(19) United States
(12) Patent Application Publication
(10) Pub. No.: US 2018/0199194 A1
(43) Pub. Date: Jul. 12, 2018

(54) METHOD AND APPARATUS FOR AUTHORIZING VEHICLE UE AND RSU UE IN WIRELESS COMMUNICATION SYSTEM

(71) Applicant: LG ELECTRONICS INC., Seoul (KR)

(72) Inventors: Jian XU, Seoul (KR); Laeyoung KIM, Seoul (KR); Daewook BYUN, Seoul (KR)

(73) Assignee: LG ELECTRONICS INC., Seoul (KR)

(21) Appl. No.: 15/742,018

(22) PCT Filed: Jul. 19, 2016
(86) PCT No.: PCT/KR2016/007854

§ 371 Date: Jan. 4, 2018

Related U.S. Application Data
(60) Provisional application No. 62/195,307, filed on Jul. 22, 2015.

(51) Int. Cl. H04W 12/06; H04W 36/00; H04W 4/40; H04W 8/02

(52) U.S. Cl. CPC H04W 12/06; H04W 8/02; H04W 4/40; H04W 36/0011

(57) ABSTRACT

A method and apparatus for transmitting authorization information for vehicle-to-everything (V2X) communication in a wireless communication system is provided. Authorization information for at least one of a vehicle user equipment (UE) or a road side unit (RSU) UE is transmitted. The authorization information for at least one of a V-UE or a RSU UE may be transmitted via various messages.

### BACKGROUND OF THE INVENTION

### Field of the Invention

The present invention relates to wireless communications, and more particularly, to a method and apparatus for authorizing a vehicle user equipment (UE) and road side unit (RSU) UE in a wireless communication system.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

The pace of LTE network deployment is accelerating all over the world, which enables more and more advanced services and Internet applications making use of the inherent benefits of LTE, such as higher data rate, lower latency and enhanced coverage. Widely deployed LTE-based network provides the opportunity for the vehicle industry to realize the concept of ‘connected cars’. By providing a vehicle with an access to the LTE network, a vehicle can be connected to the Internet and other vehicles so that a broad range of existing or new services can be envisaged. Vehicle manufacturers and cellular network operators show strong interests in vehicle wireless communications for proximity safety services as well as commercial applications. LTE-based vehicle-to-everything (V2X) study is urgently desired from market requirement, and the market for vehicle-to-vehicle (V2V) communication in particular is time sensitive. There are many research projects and field tests of connected vehicles in some countries or regions, such as US/Europe/Japan/Korea.

V2X includes a vehicle-to-vehicle (V2V), covering LTE-based communication between vehicles, vehicle-to-pedestrian (V2P), covering LTE-based communication between a vehicle and a device carried by an individual (e.g. handheld terminal carried by a pedestrian, cyclist, driver or passenger), and vehicle-to-infrastructure/network (V2I), covering LTE-based communication between a vehicle and a roadside unit (RSU)/network. A RSU is a transportation infrastructure entity (e.g. an entity transmitting speed notifications) implemented in an eNodeB (eNB) or a stationary UE.

By the introduction of vehicle UEs or RSUs implemented in a UE (i.e. RSU UEs) for V2X communication, S1 and/or X2 enhancement for vehicle UE and RSU UE authentication procedure may be required.

### SUMMARY OF THE INVENTION

The present invention provides a method and apparatus for authorizing a vehicle user equipment (UE) and road side unit (RSU) UE in a wireless communication system. The present invention provides a S1 and X2 enhancement for vehicle UE and RSU UE authentication procedure.

In an aspect, a method for transmitting authorization information for vehicle-to-everything (V2X) communication in a wireless communication system is provided. The method includes transmitting authorization information for at least one of a vehicle user equipment (UE) or a road side unit (RSU) UE.

Vehicle UE and RSU UE can be authorized efficiently.

### BRIEF DESCRIPTION OF THE DRAWINGS

FIG. 1 shows LTE system architecture.

FIG. 2 shows a block diagram of architecture of a typical E-UTRAN and a typical EPC.

FIG. 3 shows a block diagram of a user plane protocol stack of an LTE system.

FIG. 4 shows a block diagram of a control plane protocol stack of an LTE system.

FIG. 5 shows an example of a physical channel structure.

FIG. 6 shows an example of an architecture for V2X communication.

FIG. 7 shows a method for transmitting authorization information for V2X communication according to an embodiment of the present invention.

FIG. 8 shows a method for transmitting authorization information for V2X communication according to another embodiment of the present invention.

FIG. 9 shows a method for transmitting authorization information for V2X communication according to another embodiment of the present invention.

FIG. 10 shows a method for transmitting authorization information for V2X communication according to another embodiment of the present invention.

FIG. 11 shows a method for transmitting authorization information for V2X communication according to another embodiment of the present invention.

FIG. 12 shows a method for transmitting authorization information for V2X communication according to another embodiment of the present invention.

FIG. 13 shows a communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

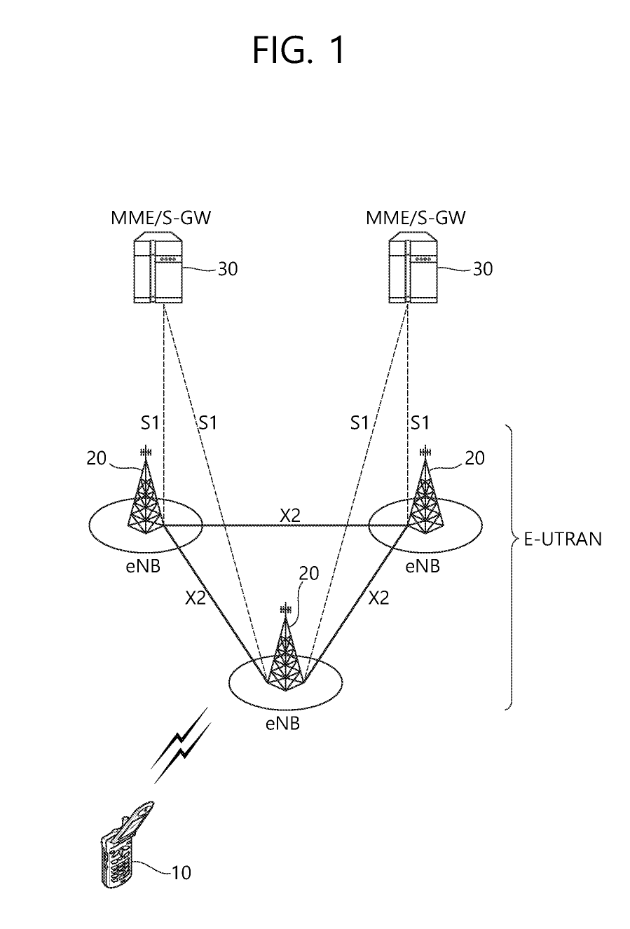

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) and a serving gateway (S-GW). The MME/S-GW 30 may be positioned at the end of the network. For clarity, MME/S-GW 30 will be referred to herein simply as a “gateway,” but it is understood that this entity includes both the MME and S-GW. A packet data network (PDN) gateway (P-GW) may be connected to an external network.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The eNBs 20 are connected to each other via an X2 interface. Neighboring eNBs may have a meshed network structure that has the X2 interface. A plurality of nodes may be connected between the eNB 20 and the gateway 30 via an S1 interface.

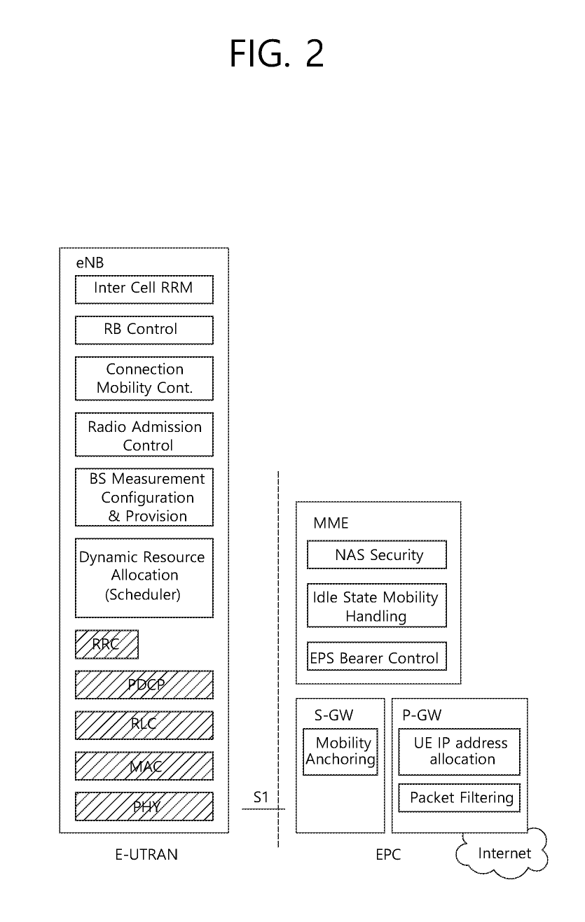

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE ACTIVE state. In the EPC, and as noted above, gateway 30 may perform functions of paging origination, LTE_IDLE state management, ciphering of the user plane, SAE bearer control, and ciphering and integrity protection of NAS signaling.

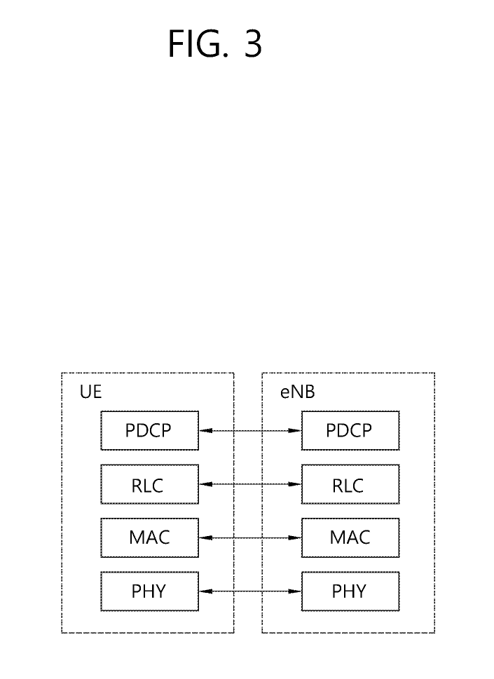

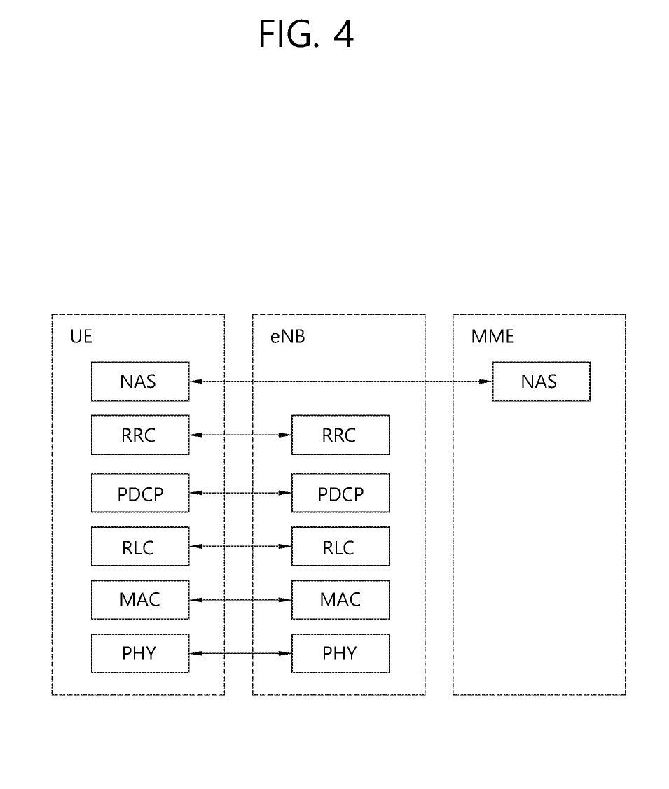

FIG. 3 shows a block diagram of a user plane protocol stack of an LTE system. FIG. 4 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e., between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or IPv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 3, the RLC and MAC layers (terminated in the eNB on the network side) may perform functions such as scheduling, automatic repeat request (ARQ), and hybrid ARQ (HARQ). The PDCP layer (terminated in the eNB on the network side) may perform the user plane functions such as header compression, integrity protection, and ciphering.

Referring to FIG. 4, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

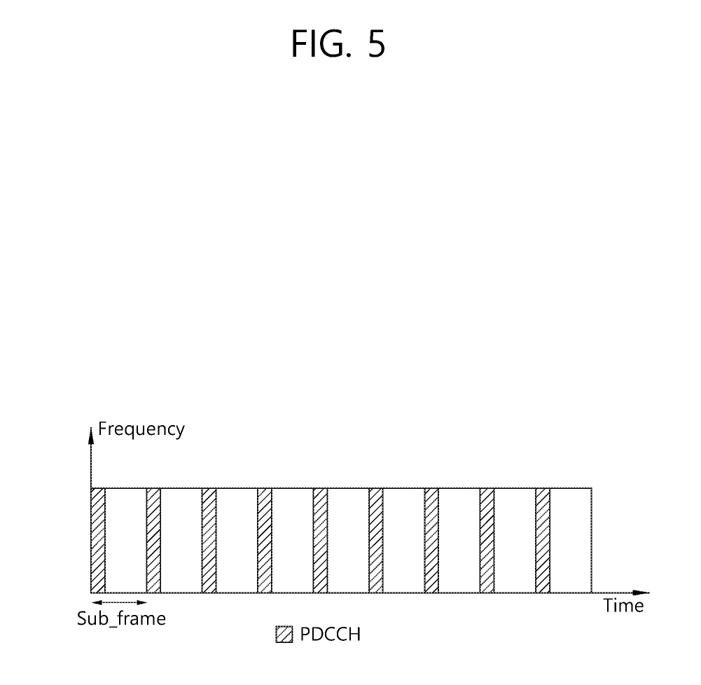

FIG. 5 shows an example of a physical channel structure. A physical channel transfers signaling and data between PHY layer of the UE and eNB with a radio resource. A physical channel consists of a plurality of subframes in time domain and a plurality of subcarriers in frequency domain. One subframe, which is 1 ms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, an uplink shared channel (UL-SCH) for transmitting user traffic or control signals, etc. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

Vehicle-to-everything (V2X) communication is described. V2X communication contains three different types, which are vehicle-to-vehicle (V2V) communications, vehicle-to-infrastructure (V2I) communications, and vehicle-to-pedestrian (V2P) communications. These three types of V2X can use “co-operative awareness” to provide more intelligent services for end-users. This means that transport entities, such as vehicles, roadside infrastructure, and pedestrians, can collect knowledge of their local environment (e.g. information received from other vehicles or sensor equipment in proximity) to process and share that knowledge in order to provide more intelligent services, such as cooperative collision warning or autonomous driving.

V2X service is a type of communication service that involves a transmitting or receiving UE using V2V application via 3GPP transport. Based on the other party involved in the communication, it can be further divided into V2V service, V2I service, V2P service, and vehicle-to-network (V2N) service. V2V service is a type of V2X service, where both parties of the communication are UEs using V2V application. V2I service is a type of V2X Service, where one party is a UE and the other party is a road side unit (RSU) both using V2I application. The RSU is an entity supporting V2I service that can transmit to, and receive from a UE using V2I application. RSU is implemented in an eNB or a stationary UE. V2P service is a type of V2X service, where both parties of the communication are UEs using V2P application. V2N service is a type of V2X Service, where one party is a UE and the other party is a serving entity, both using V2N applications and communicating with each other via LTE network entities.

For V2V, E-UTRAN allows such UEs that are in proximity of each other to exchange V2V-related information using E-UTRA(N) when permission, authorization and proximity criteria are fulfilled. The proximity criteria can be configured by the mobile network operator (MNO). However, UEs supporting V2V service can exchange such information when served by or not served by E-UTRAN which supports V2X Service. The UE supporting V2V applications transmits application layer information (e.g. about its location, dynamics, and attributes as part of the V2V service). The V2V payload must be flexible in order to accommodate different information contents, and the information can be transmitted periodically according to a configuration provided by the MNO. V2V is predominantly broadcast-based. V2V includes the exchange of V2V-related application information between distinct UEs directly and/or, due to the limited direct communication range of V2V, the exchange of V2V-related application information between distinct UEs via infrastructure supporting V2X service, e.g., RSU, application server, etc.

For V2I, the UE supporting V2I applications sends application layer information to RSU. RSU sends application layer information to a group of UEs or a UE supporting V2I applications. V2N is also introduced where one party is a UE and the other party is a serving entity, both supporting V2N applications and communicating with each other via LTE network.

For V2P, E-UTRAN allows such UEs that are in proximity of each other to exchange V2P-related information using E-UTRAN when permission, authorization and proximity criteria are fulfilled. The proximity criteria can be configured by the MNO. However, UEs supporting V2P service can exchange such information even when not served by E-UTRAN which supports V2X Service. The UE supporting V2P applications transmits application layer information. Such information can be broadcast by a vehicle with UE supporting V2X service (e.g., warning to pedestrian), and/or by a pedestrian with UE supporting V2X service (e.g., warning to vehicle). V2P includes the exchange of V2P-related application information between distinct UEs (one for vehicle and the other for pedestrian) directly and/or, due to the limited direct communication range of V2P, the exchange of V2P-related application information between distinct UEs via infrastructure supporting V2X service, e.g., RSU, application server, etc.

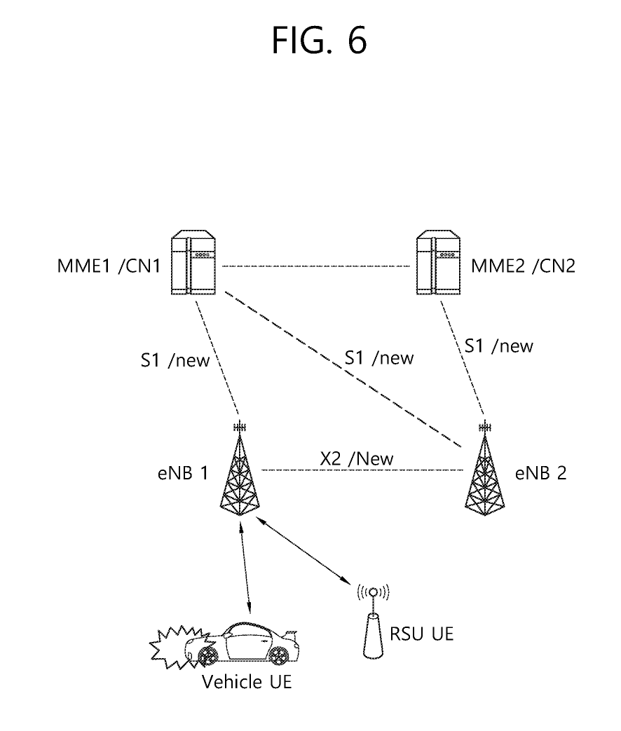

FIG. 6 shows an example of an architecture for V2X communication. Referring to FIG. 6, the existing node (i.e. eNB/MME) or new nodes may be deployed for supporting V2X communication. The interface between nodes may be S1/X2 interface or new interface. That is, the interface between eNB1 and eNB2 may be X2 interface or new interface. The interface between eNB1/eNB2 and MME1/MME2 may be S1 interface or new interface.

Further, here may be two types of UE for V2X communication, one of which is a vehicle UE and the other is the RSU UE. The vehicle UE may be like the generic UE. The RSU UE is a RSU which is implemented in the UE, and can relay or multicast or broadcast the traffic or safety information or other vehicle UEs. For V2X communication, vehicle UEs may be communicated with each other directly via PC5 interface. Alternatively, vehicle UEs may be communicated with each other indirectly via the network node. The network node may be one of an eNB, a new entity for V2X communication, a new gateway for V2X communication, a RSU, etc. The network node may not be the MME or S-GW. Alternatively, a vehicle UE may broadcast data, and the RSU UE may receive the broadcast data. The RSU and another vehicle UEs may be communicated with each other indirectly via the network node. The network node may be one of an eNB, a new entity for V2X communication, a new gateway for V2X communication, a RSU, etc. In this case, the network node may not be the MME or S-GW.

When the vehicle UE and/or RSU UE is deployed for V2X communication, the authentication problem for the vehicle UE and RSU UE may occur. Accordingly, it may be required to solve the authentication problem for the vehicle UE and RSU UE.

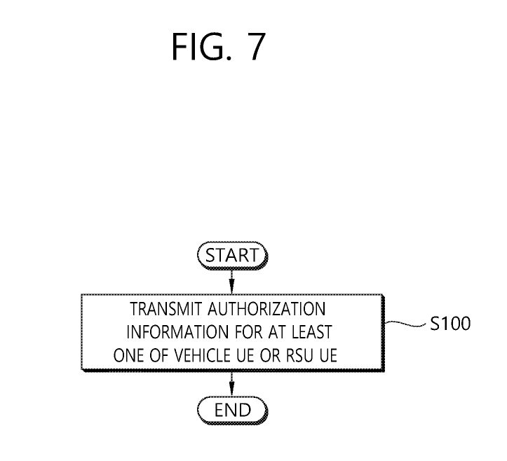

FIG. 7 shows a method for transmitting authorization information for V2X communication according to an embodiment of the present invention.

In step S100, authorization information for at least one of vehicle UE or RSU UE is transmitted. The authorization information for the vehicle UE may be “Vehicle UE Authorized” information element (IE), which may be included in an existing message or a new message. The authorization information for the vehicle UE (or “Vehicle UE Authorized” IE) provides information on the authorization status of the vehicle UE for V2X services. That is, the authorization information for the vehicle UE indicates whether the UE is authorized as vehicle UE or not. The authorization information for the RSU UE may be “RSU UE Authorized” IE, which may be included in an existing message or a new message. The authorization information for the RSU UE (or “RSU UE Authorized” IE) provides information on the authorization status of the RSU UE for V2X services. That is, the authorization information for the RSU UE indicates whether the UE is authorized as RSU UE or not. Table 1 and 2 show an example of “Vehicle UE Authorized” IE and “RSU UE Authorized” IE, respectively.

TABLE 1

| IE/Group | | | IE type and | Semantics |
|---|---|---|---|---|
| Name | Presence | Range | reference | description |
| Vehicle UE | O | | ENUMERATED | Indicates whether |
| Authorized | | | (authorized, | the UE is |
| | | | not | authorized |
| | | | authorized, . . . ) | for Vehicle |
| | | | | UE or not |

TABLE 2

| IE/Group | | | IE type and | Semantics |
|---|---|---|---|---|
| Name | Presence | Range | reference | description |
| RSU UE | O | | ENUMERATED | Indicates whether |
| Authorized | | | (authorized, | the UE is |
| | | | not | authorized |
| | | | authorized, . . . ) | for RSU UE |
| | | | | or not |

Referring to Table 1, “Vehicle UE Authorized” IE indicates whether the UE is authorized for vehicle UE or not. Referring to Table 2, “RSU UE Authorized” IE indicates whether the UE is authorized for RSU UE or not.

The authorization information for at least one of vehicle UE or RSU UE may be transmitted during initial attach/service request stage or during the MME triggered UE context modification procedure. In this case, the authorization information for at least one of vehicle UE or RSU UE may be transmitted from the MME to the eNB. For example, the authorization information for at least one of vehicle UE or RSU UE may be transmitted during an initial context setup procedure in such as attach, service request, etc., via an initial context setup request message. Alternatively, the authorization information for at least one of vehicle UE or RSU UE may be transmitted via a UE context modification request message.

Alternatively, the authorization information for at least one of vehicle UE or RSU UE may be transmitted during mobility procedure. For X2 handover procedure, the authorization information for at least one of vehicle UE or RSU UE may be transmitted from the source eNB to the target eNB via the handover request message. Further, the authorization information for at least one of vehicle UE or RSU UE may be updated and transmitted from the MME to the eNB via a path switch request acknowledge message. For S1 handover procedure, the authorization information for at least one of vehicle UE or RSU UE may be transmitted from the MME to the target eNB via the handover request message.

Hereinafter, various embodiments of the present invention for transmitting the authorization information for at least one of vehicle UE or RSU UE are described.

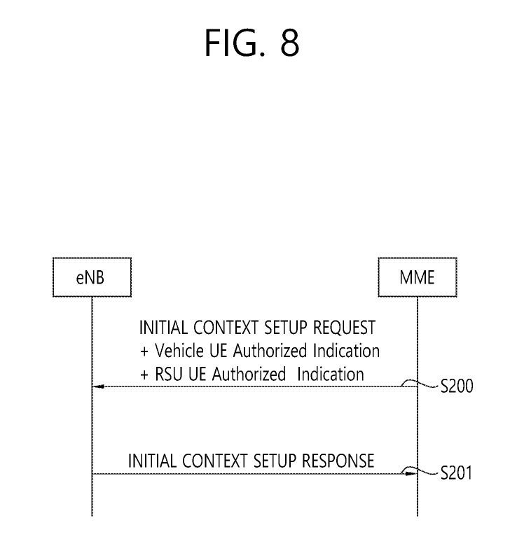

FIG. 8 shows a method for transmitting authorization information for V2X communication according to another embodiment of the present invention. This embodiment corresponds authentication during initial attach/service request, specifically the procedure involving the initial context setup procedure in such as attach, service request, etc.

In step S200, the MME transmits an initial context setup request message to the eNB. The initial context setup request message is sent by the MME to request the setup of a UE context. The initial context setup request message may include at least one of the authorization information for the vehicle UE, i.e. “Vehicle UE Authorized” IE, or the authorization information for the RSU UE, i.e. “RSU UE Authorized” IE. Table 3 shows an example of the initial context setup request message according to an embodiment of the present invention.

TABLE 3

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| MME UE S1AP | M | | 9.2.3.3 | | YES | reject |
| ID | | | | | | |
| eNB UE S1AP ID | M | | 9.2.3.4 | | YES | reject |
| UE Aggregate | M | | 9.2.1.20 | | YES | reject |
| Maximum Bit Rate | | | | | | |
| E-RAB to Be | | 1 | | | YES | reject |
| Setup List | | | | | | |
| >E-RAB to Be | | 1 . . . | | | EACH | reject |
| Setup Item IEs | | <maxnoofE- | | | | |
| | | RABs> | | | | |
| >>E-RAB ID | M | | 9.2.1.2 | | — | |
| >>E-RAB Level | M | | 9.2.1.15 | Includes | — | |
| QoS Parameters | | | | necessary | | |
| | | | | QoS | | |
| | | | | parameters. | | |
| >>Transport Layer | M | | 9.2.2.1 | | — | |
| Address | | | | | | |
| >>GTP-TEID | M | | 9.2.2.2 | | — | |
| >>NAS-PDU | O | | 9.2.3.5 | | — | |
| >Correlation ID | O | | 9.2.1.80 | | YES | ignore |
| >>SIPTO | O | | Correlation ID | | YES | ignore |
| Correlation ID | | | 9.2.1.80 | | | |
| UE Security | M | | 9.2.1.40 | | YES | reject |
| Capabilities | | | | | | |
| Security Key | M | | 9.2.1.41 | The KeNB is | YES | reject |
| | | | | provided | | |
| | | | | after the key- | | |
| | | | | generation in | | |
| | | | | the MME, | | |
| | | | | see TS | | |
| | | | | 33.401 [15]. | | |
| Trace Activation | O | | 9.2.1.4 | | YES | ignore |
| Handover | O | | 9.2.1.22 | | YES | ignore |
| Restriction List | | | | | | |
| UE Radio | O | | 9.2.1.27 | | YES | ignore |
| Capability | | | | | | |
| Subscriber Profile | O | | 9.2.1.39 | | YES | ignore |
| ID for | | | | | | |
| RAT/Frequency | | | | | | |
| priority | | | | | | |
| CS Fallback | O | | 9.2.3.21 | | YES | reject |
| Indicator | | | | | | |
| SRVCC Operation | O | | 9.2.1.58 | | YES | ignore |
| Possible | | | | | | |
| CSG Membership | O | | 9.2.1.73 | | YES | ignore |
| Status | | | | | | |
| Registered LAI | O | | 9.2.3.1 | | YES | ignore |
| GUMMEI | O | | 9.2.3.9 | This IE | YES | ignore |
| | | | | indicates the | | |
| | | | | MME | | |
| | | | | serving the | | |
| | | | | UE. | | |
| MME UE S1AP | O | | 9.2.3.3 | This IE | YES | ignore |
| ID 2 | | | | indicates the | | |
| | | | | MME UE | | |
| | | | | S1AP ID | | |
| | | | | assigned by | | |
| | | | | the MME. | | |
| Management | O | | 9.2.1.83 | | YES | ignore |
| Based MDT | | | | | | |
| Allowed | | | | | | |
| Management | O | | MDT | | YES | ignore |
| Based MDT | | | PLMN | | | |
| PLMN List | | | List | | | |
| | | | 9.2.1.89 | | | |
| Additional CS | C- | | 9.2.3.37 | | YES | ignore |
| Fallback Indicator | ifCSFBhighpriority | | | | | |
| Masked IMEISV | O | | 9.2.3.38 | | YES | ignore |
| Expected UE | O | | 9.2.1.96 | | YES | ignore |
| Behaviour | | | | | | |
| ProSe Authorized | O | | 9.2.1.99 | | YES | ignore |
| Vehicle UE | O | | 9.2.1.XX | | YES | ignore |
| Authorized | | | | | | |
| RSU UE | O | | 9.2.1.XX | | YES | ignore |
| Authorized | | | | | | |

Referring to Table 3, the initial context setup request message may include “Vehicle UE Authorized” IE, shown in Table 1 above, or “RSU UE Authorized” IE, shown in Table 2 above.

Upon receipt of the initial context setup request message, the eNB may store the received authorization information for at least one of the vehicle UE or RSU UE, if supported, in the UE context. In step S201, the eNB transmits an initial context setup response message to the MME.

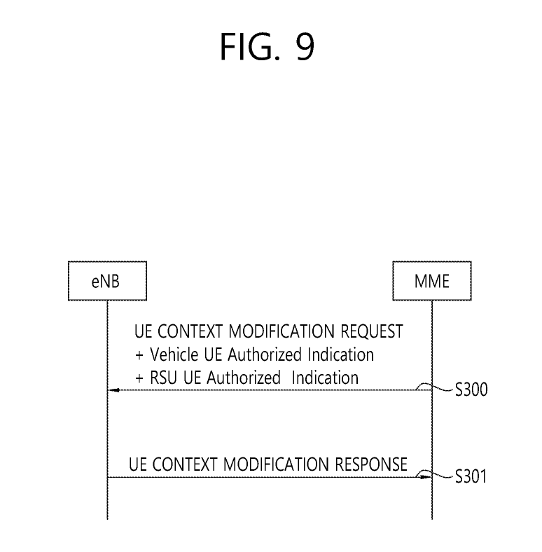

FIG. 9 shows a method for transmitting authorization information for V2X communication according to another embodiment of the present invention. This embodiment corresponds to authentication during the MME triggered UE context modification procedure.

In step S300, the MME transmits an UE context modification request message to the eNB. The UE context modification request message is sent by the MME to provide UE context information changes to the eNB. The UE context modification request message may include at least one of the authorization information for the vehicle UE, i.e. “Vehicle UE Authorized” IE, or the authorization information for the RSU UE, i.e. “RSU UE Authorized” IE. Table 4 shows an example of the UE context modification request message according to an embodiment of the present invention.

TABLE 4

| | | | | | | |
|---|---|---|---|---|---|---|
| | | | IE type | | | |
| | | | and | Semantics | | Assigned |
| IE/Group Name | Presence | Range | reference | description | Criticality | Criticality |

| | | | | | |
|---|---|---|---|---|---|
| Message Type | M | 9.2.1.1 | | YES | reject |
| MME UE S1AP ID | M | 9.2.3.3 | | YES | reject |
| eNB UE S1AP ID | M | 9.2.3.4 | | YES | reject |
| Security Key | O | 9.2.1.41 | A fresh KeNB is | YES | reject |
| | | | provided after | | |
| | | | performing a key- | | |
| | | | change on the fly | | |
| | | | procedure in the | | |
| | | | MME, see TS 33.401 | | |
| | | | [15]. | | |
| Subscriber Profile | O | 9.2.1.39 | | YES | ignore |
| ID for | | | | | |
| RAT/Frequency | | | | | |
| priority | | | | | |
| UE Aggregate | O | 9.2.1.20 | | YES | ignore |
| Maximum Bit Rate | | | | | |
| CS Fallback | O | 9.2.3.21 | | YES | reject |
| Indicator | | | | | |
| UE Security | O | 9.2.1.40 | | YES | reject |
| Capabilities | | | | | |
| CSG Membership | O | 9.2.1.73 | | YES | ignore |
| Status | | | | | |
| Registered LAI | O | 9.2.3.1 | | YES | ignore |
| Additional CS | C- | 9.2.3.37 | | YES | ignore |
| Fallback Indicator | ifCSFBhighpriority | | | | |
| ProSe Authorized | O | 9.2.1.99 | | YES | ignore |
| Vehicle UE | O | 9.2.1.XX | | YES | ignore |
| Authorized | | | | | |
| RSU UE Authorized | O | 9.2.1.XX | | YES | ignore |

Referring to Table 4, the UE context modification request message may include “Vehicle UE Authorized” IE, shown in Table 1 above, or “RSU UE Authorized” IE, shown in Table 2 above.

If “Vehicle UE Authorized” IE or “RSU UE Authorized” IE is contained in the UE context modification request message, the eNB may, if supported, update its authorization information for the corresponding UE accordingly. If “Vehicle UE Authorized” IE or “RSU UE Authorized” IE is set to “not authorized”, the eNB may, if supported, initiate actions to ensure that the corresponding UE is no longer accessing the relevant V2X services. In step S301, the eNB transmits an UE context modification response message to the MME.

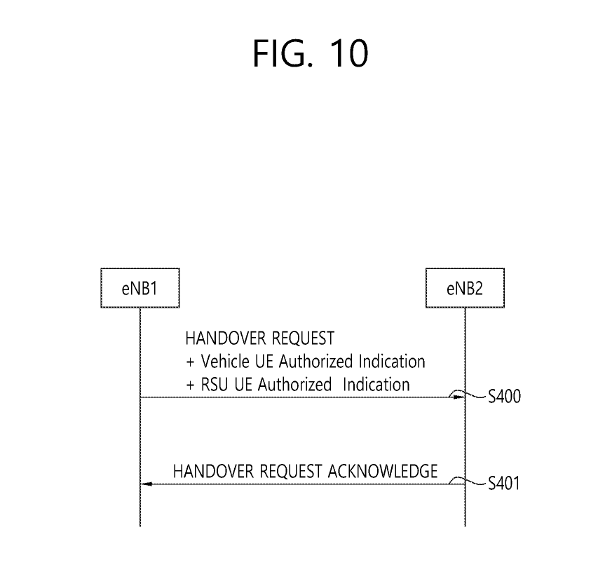

FIG. 10 shows a method for transmitting authorization information for V2X communication according to another embodiment of the present invention. This embodiment corresponds to authentication during mobility procedure, specifically X2 handover procedure.

In step S400, the eNB1 transmits a handover request message to the eNB2. The handover request message is sent by the source eNB to the target eNB to request the preparation of resources for a handover. The handover request message may include at least one of the authorization information for the vehicle UE, i.e. “Vehicle UE Authorized” IE, or the authorization information for the RSU UE, i.e. “RSU UE Authorized” IE. Table 5 shows an example of the handover request message according to an embodiment of the present invention.

TABLE 5

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.13 | | YES | reject |
| Old eNB UE X2AP | M | | eNB UE | Allocated at | YES | reject |
| ID | | | X2AP | the source | | |
| | | | ID | eNB | | |
| | | | 9.2.24 | | | |
| Cause | M | | 9.2.6 | | YES | ignore |
| Target Cell ID | M | | ECGI | | YES | reject |
| | | | 9.2.14 | | | |
| GUMMEI | M | | 9.2.16 | | YES | reject |
| UE Context | | 1 | | | YES | reject |
| Information | | | | | | |
| >MME UE S1AP ID | M | | INTEGER | MME UE | — | — |
| | | | (0 . . . 2³² − 1) | S1AP ID | | |
| | | | | allocated at | | |
| | | | | the MME | | |
| >UE Security | M | | 9.2.29 | | — | — |
| Capabilities | | | | | | |
| >AS Security | M | | 9.2.30 | | — | — |
| Information | | | | | | |
| >UE Aggregate | M | | 9.2.12 | | — | — |
| Maximum Bit Rate | | | | | | |
| >Subscriber Profile | O | | 9.2.25 | | — | — |
| ID for | | | | | | |
| RAT/Frequency | | | | | | |
| priority | | | | | | |
| >E-RABs To Be | | 1 | | | — | — |
| Setup List | | | | | | |
| >>E-RABs To Be | | 1 . . . | | | EACH | ignore |
| Setup Item | | <maxnoof | | | | |
| | | Bearers> | | | | |
| >>>E-RAB ID | M | | 9.2.23 | | — | — |
| >>>E-RAB Level | M | | 9.2.9 | Includes | — | — |
| QoS Parameters | | | | necessary | | |
| | | | | QoS | | |
| | | | | parameters | | |
| >>>DL Forwarding | O | | 9.2.5 | | — | — |
| >>>UL GTP Tunnel | M | | GTP | SGW | — | — |
| Endpoint | | | Tunnel | endpoint of | | |
| | | | Endpoint | the S1 | | |
| | | | 9.2.1 | transport | | |
| | | | | bearer. For | | |
| | | | | delivery of | | |
| | | | | UL PDUs. | | |
| >RRC Context | M | | OCTET | Includes the | — | — |
| | | | STRING | RRC | | |
| | | | | Handover | | |
| | | | | Preparation | | |
| | | | | Information | | |
| | | | | message as | | |
| | | | | defined in | | |
| | | | | subclause | | |
| | | | | 10.2.2 of TS | | |
| | | | | 36.331 [9] | | |
| >Handover | O | | 9.2.3 | | — | — |
| Restriction List | | | | | | |
| >Location Reporting | O | | 9.2.21 | Includes the | — | — |
| Information | | | | necessary | | |
| | | | | parameters | | |
| | | | | for location | | |
| | | | | reporting | | |
| >Management | O | | 9.2.59 | | YES | ignore |
| Based MDT | | | | | | |
| Allowed | | | | | | |
| >Management | O | | MDT | | YES | ignore |
| Based MDT PLMN | | | PLMN | | | |
| List | | | List | | | |
| | | | 9.2.64 | | | |
| UE History | M | | 9.2.38 | Same | YES | ignore |
| Information | | | | definition as | | |
| | | | | in TS 36.413 | | |
| | | | | [4] | | |
| Trace Activation | O | | 9.2.2 | | YES | ignore |
| SRVCC Operation | O | | 9.2.33 | | YES | ignore |
| Possible | | | | | | |
| CSG Membership | O | | 9.2.52 | | YES | reject |
| Status | | | | | | |
| Mobility | O | | BIT | Information | YES | ignore |
| Information | | | STRING | related to the | | |
| | | | (SIZE | handover; the | | |
| | | | (32)) | source eNB | | |
| | | | | provides it in | | |
| | | | | order to | | |
| | | | | enable later | | |
| | | | | analysis of | | |
| | | | | the conditions | | |
| | | | | that led to a | | |
| | | | | wrong HO. | | |
| Masked IMEISV | O | | 9.2.69 | | YES | ignore |
| UE History | O | | OCTET | VisitedCellInfoList | YES | ignore |
| Information from | | | STRING | contained in the | | |
| the UE | | | | UEInformationResponse | | |
| | | | | message (TS | | |
| | | | | 36.331 [9]) | | |
| Expected UE | O | | 9.2.70 | | YES | ignore |
| Behaviour | | | | | | |
| ProSe Authorized | O | | 9.2.78 | | YES | ignore |
| Vehicle UE | O | | 9.2.XX | | YES | ignore |
| Authorized | | | | | | |
| RSU UE | O | | 9.2.XX | | YES | ignore |
| Authorized | | | | | | |

Referring to Table 5, the handover request message may include “Vehicle UE Authorized” IE, shown in Table 1 above, or “RSU UE Authorized” IE, shown in Table 2 above.

If “Vehicle UE Authorized” IE or “RSU UE Authorized” IE is contained in the handover request message, and it contains one or more IEs set to “authorized”, the target eNB may, if supported, consider that the corresponding UE is authorized for the relevant V2X services. In step S401, the eNB2 transmits a handover request acknowledge message to the eNB1.

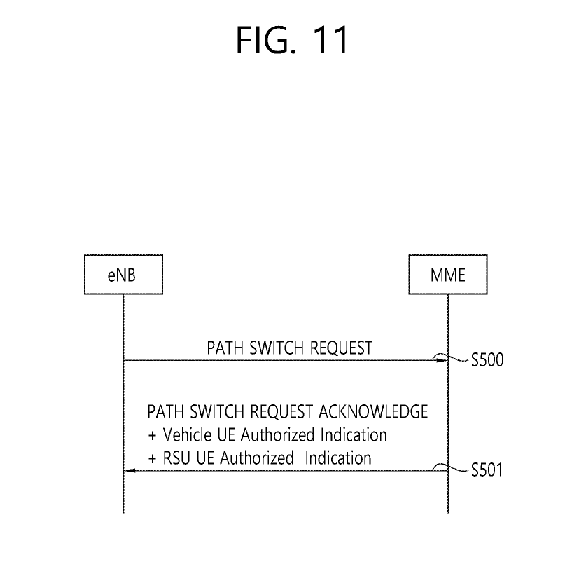

FIG. 11 shows a method for transmitting authorization information for V2X communication according to another embodiment of the present invention. During the X2 handover procedure, the authorization information for vehicle UE or RSU UE may be updated in some case. This embodiment corresponds to update of authentication during mobility procedure, specifically X2 handover procedure.

In step S500, the eNB transmits a path switch request message to the MME. In step S501, the MME eNB transmits a path switch request acknowledge message to the eNB. The path switch request acknowledge message is sent by the MME to inform the eNB that the path switch has been successfully completed in the EPC. The path switch request acknowledge message may include at least one of the authorization information for the vehicle UE, i.e. “Vehicle UE Authorized” IE, or the authorization information for the RSU UE, i.e. “RSU UE Authorized” IE. Table 6 shows an example of the path switch request acknowledge message according to an embodiment of the present invention.

TABLE 6

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| MME UE S1AP ID | M | | 9.2.3.3 | | YES | ignore |
| eNB UE S1AP ID | M | | 9.2.3.4 | | YES | ignore |
| UE Aggregate | O | | 9.2.1.20 | | YES | ignore |
| Maximum Bit Rate | | | | | | |
| E-RAB To Be | | 0 . . . 1 | | | YES | ignore |
| Switched in Uplink | | | | | | |
| List | | | | | | |
| >E-RABs Switched | | 1 . . . | | | EACH | ignore |
| in Uplink Item IEs | | <maxnoofE- | | | | |
| | | RABs> | | | | |
| >>E-RAB ID | M | | 9.2.1.2 | | — | |
| >>Transport Layer | M | | 9.2.2.1 | | — | |
| Address | | | | | | |
| >>GTP-TEID | M | | 9.2.2.2 | | — | |
| E-RAB To Be | O | | E-RAB | A value for | YES | ignore |
| Released List | | | List | E-RAB ID | | |
| | | | 9.2.1.36 | shall only | | |
| | | | | be present | | |
| | | | | once in E- | | |
| | | | | RAB To Be | | |
| | | | | Switched in | | |
| | | | | Uplink List | | |
| | | | | IE and E- | | |
| | | | | RAB to Be | | |
| | | | | Released | | |
| | | | | List IE. | | |
| Security Context | M | | 9.2.1.26 | One pair of | YES | reject |
| | | | | {NCC, NH} | | |
| | | | | is provided. | | |
| Criticality | O | | 9.2.1.21 | | YES | ignore |
| Diagnostics | | | | | | |
| MME UE S1AP ID | O | | 9.2.3.3 | This IE | YES | ignore |
| 2 | | | | indicates the | | |
| | | | | MME UE | | |
| | | | | S1AP ID | | |
| | | | | assigned by | | |
| | | | | the MME. | | |
| CSG Membership | O | | 9.2.1.73 | | YES | ignore |
| Status | | | | | | |
| ProSe Authorized | O | | 9.2.1.99 | | YES | ignore |
| Vehicle UE | O | | 9.2.1.XX | | YES | ignore |
| Authorized | | | | | | |
| RSU UE | O | | 9.2.1.XX | | YES | ignore |
| Authorized | | | | | | |

Referring to Table 6, the path switch request acknowledge message may include “Vehicle UE Authorized” IE, shown in Table 1 above, or “RSU UE Authorized” IE, shown in Table 2 above.

If “Vehicle UE Authorized” IE or “RSU UE Authorized” IE is contained in the path switch request acknowledge message, the eNB may, if supported, update its authorization information for the corresponding UE accordingly. If “Vehicle UE Authorized” IE or “RSU UE Authorized” IE is set to “not authorized”, the eNB may, if supported, initiate actions to ensure that the corresponding UE is no longer accessing the relevant V2X services.

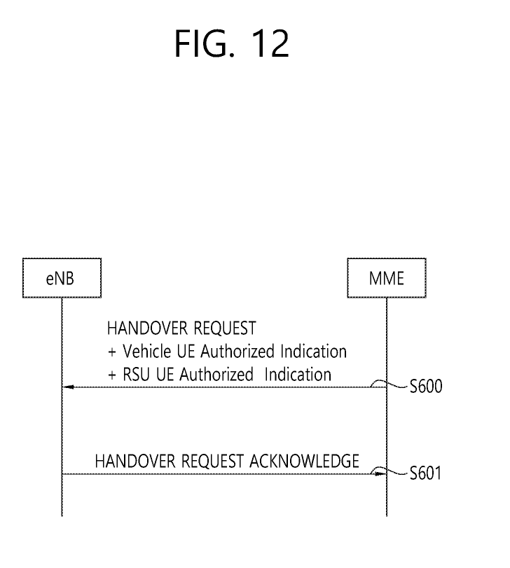

FIG. 12 shows a method for transmitting authorization information for V2X communication according to another embodiment of the present invention. This embodiment corresponds to authentication during mobility procedure, specifically S1 handover procedure.

In step S600, the MME transmits a handover request message to the target eNB. The handover request message is sent by the MME to the target eNB to request the preparation of resources. The handover request message may include at least one of the authorization information for the vehicle UE, i.e. “Vehicle UE Authorized” IE, or the authorization information for the RSU UE, i.e. “RSU UE Authorized” IE. Table 7 shows an example of the handover request message according to an embodiment of the present invention.

TABLE 7

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| Handover Type | M | | 9.2.1.13 | | YES | reject |
| Cause | M | | 9.2.1.3 | | YES | ignore |
| UE Aggregate | M | | 9.2.1.20 | | YES | reject |
| Maximum Bit Rate | | | | | | |
| E-RABs To Be | | 1 | | | YES | reject |
| Setup List | | | | | | |
| >E-RABs To Be | | 1 . . . | | | EACH | reject |
| Setup Item IEs | | <maxnoofE- | | | | |
| | | RABs> | | | | |
| >>E-RAB ID | M | | 9.2.1.2 | | — | |
| >>Transport Layer | M | | 9.2.2.1 | | — | |
| Address | | | | | | |
| >>GTP-TEID | M | | 9.2.2.2 | To deliver UL | — | |
| | | | | PDUs. | | |
| >>E-RAB Level | M | | 9.2.1.15 | Includes | — | |
| QoS Parameters | | | | necessary QoS | | |
| | | | | parameters. | | |
| >>Data Forwarding | O | | 9.2.1.76 | | YES | ignore |
| Not Possible | | | | | | |
| Source to Target | M | | 9.2.1.56 | | YES | reject |
| Transparent | | | | | | |
| Container | | | | | | |
| UE Security | M | | 9.2.1.40 | | YES | reject |
| Capabilities | | | | | | |
| Handover | O | | 9.2.1.22 | | YES | ignore |
| Restriction List | | | | | | |
| Trace Activation | O | | 9.2.1.4 | | YES | ignore |
| Request Type | O | | 9.2.1.34 | | YES | ignore |
| SRVCC Operation | O | | 9.2.1.58 | | YES | ignore |
| Possible | | | | | | |
| Security Context | M | | 9.2.1.26 | | YES | reject |
| NAS Security | C- | | 9.2.3.31 | The eNB shall | YES | reject |
| Parameters to E- | iffrom | | | use this IE as | | |
| UTRAN | UTRANGERAN | | | specified in TS | | |
| | | | | 33.401 [15]. | | |
| CSG Id | O | | 9.2.1.62 | | YES | reject |
| CSG Membership | O | | 9.2.1.73 | | YES | ignore |
| Status | | | | | | |
| GUMMEI | O | | 9.2.3.9 | This IE | YES | ignore |
| | | | | indicates the | | |
| | | | | MME serving | | |
| | | | | the UE. | | |
| MME UE S1AP ID | O | | 9.2.3.3 | This IE | YES | ignore |
| 2 | | | | indicates the | | |
| | | | | MME UE | | |
| | | | | S1AP ID | | |
| | | | | assigned by the | | |
| | | | | MME. | | |
| Management Based | O | | 9.2.1.83 | | YES | ignore |
| MDT Allowed | | | | | | |
| Management Based | O | | MDT | | YES | ignore |
| MDT PLMN List | | | PLMN | | | |
| | | | List | | | |
| | | | 9.2.1.89 | | | |
| Masked IMEISV | O | | 9.2.3.38 | | YES | ignore |
| Expected UE | O | | 9.2.1.96 | | YES | ignore |
| Behaviour | | | | | | |
| ProSe Authorized | O | | 9.2.1.99 | | YES | ignore |
| Vehicle UE | O | | 9.2.1.XX | | YES | ignore |
| Authorized | | | | | | |
| RSU UE | O | | 9.2.1.XX | | YES | ignore |
| Authorized | | | | | | |

Referring to Table 7, the handover request message may include “Vehicle UE Authorized” IE, shown in Table 1 above, or “RSU UE Authorized” IE, shown in Table 2 above.

If “Vehicle UE Authorized” IE or “RSU UE Authorized” IE is contained in the handover request message, and it contains one or more IEs set to “authorized”, the target eNB may, if supported, consider that the corresponding UE is authorized for the relevant V2X services. In step S601, the target eNB transmits a handover request acknowledge message to the MME.

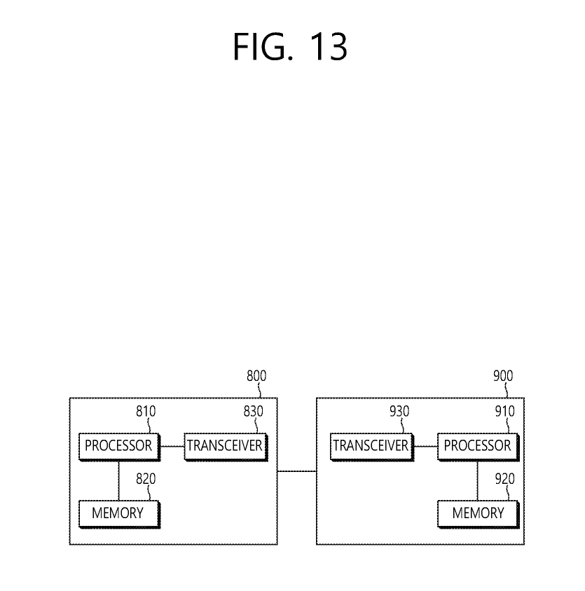

FIG. 13 shows a communication system to implement an embodiment of the present invention.

An eNB 800 may include a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A MME 900 may include a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for transmitting authorization information for vehicle-to-everything (V2X) communication in a wireless communication system, the method comprising:
transmitting authorization information for at least one of a vehicle user equipment (UE) or a road side unit (RSU) UE.

2. The method of claim 1, wherein the authorization information for at least one of vehicle UE or RSU UE is transmitted by a mobility management entity (MME) to an eNodeB (eNB).

3. The method of claim 2, wherein the authorization information for at least one of vehicle UE or RSU UE is transmitted during an initial context setup procedure.

4. The method of claim 3, wherein the authorization information for at least one of vehicle UE or RSU UE is transmitted via an initial context setup request message.

5. The method of claim 2, wherein the authorization information for at least one of vehicle UE or RSU UE is transmitted during an MME triggered UE context modification procedure.

6. The method of claim 5, wherein the authorization information for at least one of vehicle UE or RSU UE is transmitted via a UE context modification request message.

7. The method of claim 2, wherein the authorization information for at least one of vehicle UE or RSU UE is transmitted during an S1 handover procedure.

8. The method of claim 7, wherein the authorization information for at least one of vehicle UE or RSU UE is transmitted via a handover request message.

9. The method of claim 1, wherein the authorization information for at least one of vehicle UE or RSU UE is transmitted by a source eNB to a target eNB during a X2 handover procedure.

10. The method of claim 9, wherein the authorization information for at least one of vehicle UE or RSU UE is transmitted via a handover request message.

11. The method of claim 9, wherein an update of the authorization information for at least one of vehicle UE or RSU UE is transmitted by a MME to an eNB.

12. The method of claim 11, wherein the update of the authorization information for at least one of vehicle UE or RSU UE is transmitted via a path switch request acknowledge message.
